(19) United States
(12) Patent Application Publication
(10) Pub. No.: US 2003/0065574 A1
(43) Pub. Date: Apr. 3, 2003

(54) System and method for order-based management

(76) Inventor: Lorraine Lawrence, Katy, TX (US)

Correspondence Address: AKIN, GUMP, STRAUSS, HAUER & FELD, 711 LOUISIANA STREET, SUITE 1900 SOUTH, HOUSTON, TX, 77002, US

(21) Appl. No.: 09/967,609

(22) Filed: Sep. 29, 2001

(51) Int. Cl. G06F 17/60

(52) U.S. Cl. 705/26

(57) ABSTRACT

A system for order-based management is provided, such as where each order is scheduled for manufacturing as it is received. The system includes an order management system that receives customer order data and generates order approval data. An order planning system receives the order approval data and generates order planning data and feedback data, such as customer order correction data. A materials system receives the order planning data and generates materials order data and feedback data, such as order planning delay data. A manufacturing operations system receives materials receipt data and generates manufacturing completion data and feedback data, such as materials order incomplete data. A shipping system receives the manufacturing completion data and generates shipping date data and feedback data, such as manufacturing incomplete data.

### CROSS-REFERENCE TO RELATED APPLICATIONS

Not Applicable.

### STATEMENTS REGARDING FEDERALLY SPONSORED RESEARCH OR DEVELOPMENT

Not Applicable.

### REFERENCE TO A MICROFICHE APPENDIX

Not Applicable.

### BACKGROUND OF THE INVENTION

1. Field of the Invention

The present invention relates generally to order processing systems or methods, and more particularly, to order-based management systems.

2. Description of the Related Art

The Order-based management systems are known in the art. Such order-based management systems allow users (such as businesses, organizations, retail outlets, shopping center, or other suitable organizations providing goods or services) to track limited classes of order data, such as when an order was placed, when it is expected to be shipped, and whether the order has been shipped.

While these existing systems provide rudimentary order status, they provide no information about how the order is being processed internally. Thus, if the order is going to be shipped after the target ship date, then that typically cannot be determined until after that date has passed. Furthermore, there is no notification mechanism for prior art systems, such as to notify an operator that the shipment date has passed.

### SUMMARY OF THE INVENTION

In accordance with the present invention, a system and method for order-based management are provided that overcome known problems with order-based management.

In particular, a system and method for order-based management are disclosed that generate feedback data at each stage in the order fulfillment process so as to allow an operator to determine which stages are causing delay in order fulfillment and to take appropriate corrective measures.

In accordance with an exemplary embodiment of the present invention, a system for order-based management is provided, such as where each order is scheduled for manufacturing as it is received. The system includes an order management system that receives customer order data and generates order approval data. An order planning system receives the order approval data and generates order planning data and feedback data, such as customer order correction data. A materials system receives the order planning data and generates materials order data and feedback data, such as order planning delay data. A manufacturing operations system receives materials receipt data and generates manufacturing completion data and feedback data, such as materials order incomplete data. A shipping system receives the manufacturing completion data and generates shipping date data and feedback data, such as manufacturing incomplete data.

The present invention provides many important technical advantages. One important technical advantage is a system for order-based management that allows a seller of goods to determine the status of an order through the use of the feedback data at each stage of the order fulfillment process. This feedback data can allow an operator to identify those stages that may require improvement, such as stages that fail to meet scheduled dates more often than other stages and stages that introduce errors that result in delays at other stages.

Those skilled in the art will further appreciate the advantages and superior features of the invention together with other important aspects thereof on reading the detailed description that follows in conjunction with the drawings.

### BRIEF DESCRIPTION OF THE SEVERAL VIEWS OF THE DRAWINGS

FIG. 1 is a diagram of a system for order-based management in accordance with an exemplary embodiment of the present invention;

FIG. 2 is a diagram of a system for receiving customer order data and generating order approval data in accordance with an exemplary embodiment of the present invention;

FIG. 3 is a diagram of a system for generating order planning data and order planning feedback data in accordance with an exemplary embodiment of the present invention;

FIG. 4 is a diagram of a system for providing feedback data during and subsequent to manufacturing operations in accordance with an exemplary embodiment of the present invention;

FIG. 5 is a diagram of a system for generating shipping date data and feedback data in accordance with an exemplary embodiment of the present invention;

FIG. 6 is a flowchart of a method for order-based management in accordance with an exemplary embodiment of the present invention;

FIG. 7 is a flowchart of a method for receiving customer orders and generating order approval data in accordance with an exemplary embodiment of the present invention;

FIG. 8 is a flowchart of a method for generating order planning data and feedback data in accordance with an exemplary embodiment of the present invention; and

FIG. 9 is a flowchart of a method for generating manufacturing completion data and feedback data in accordance with an exemplary embodiment of the present invention.

### DETAILED DESCRIPTION OF THE INVENTION

In the description that follows, like parts are marked throughout the specification and drawings with the same reference numerals, respectively. The drawing figures might not be to scale and certain components can be shown in generalized or schematic form and identified by commercial designations in the interest of clarity and conciseness.

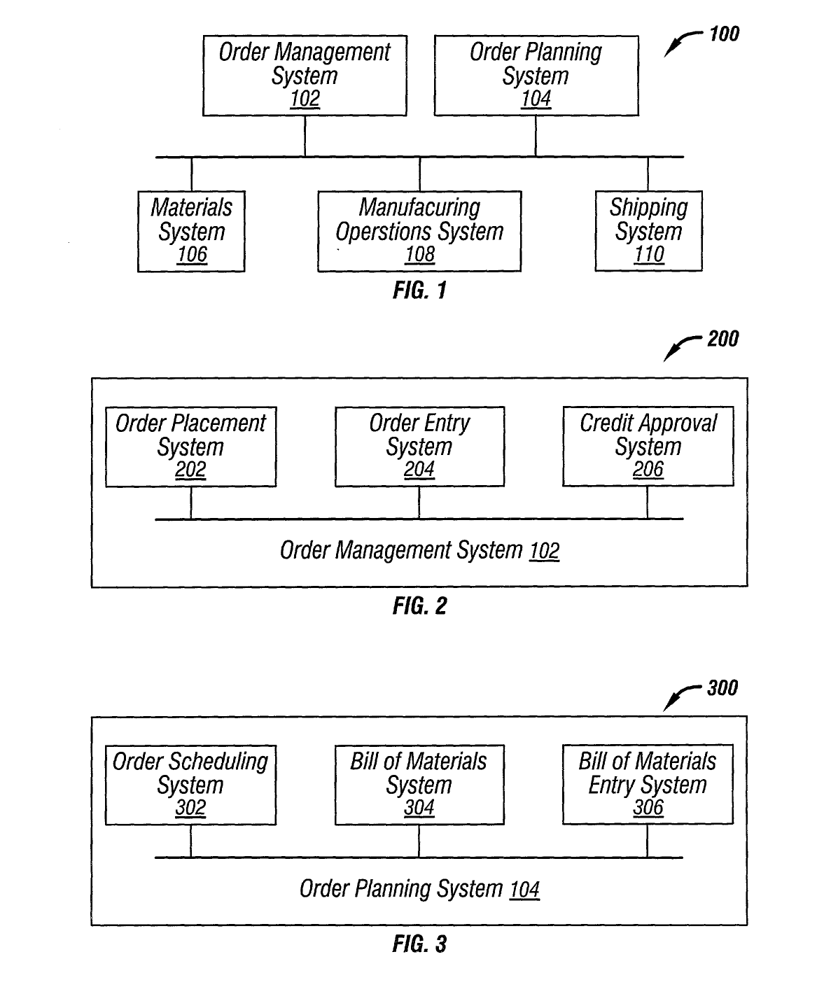

FIG. 1 is a diagram of a system 100 for order-based management in accordance with an exemplary embodiment of the present invention. System 100 allows a user to generate and review feedback data and other suitable data to improve order processing.

System 100 includes order management system 102, which can be implemented in hardware, software, or a suitable combination of hardware and software, and which can be one or more software systems operating on a general purpose server platform. As used herein, a software system can include one or more objects, agents, threads, subroutines, separate software applications, human readable code, object code, machine readable code, source code, two or more lines of code or other suitable software structures operating in two or more separate software applications, on two or more different processors, or other suitable software architectures. In one exemplary embodiment, a software system can include one or more lines of code or other suitable software structures operating in a general purpose software application, such as an operating system, and one or more lines of code or other suitable software structures operating in a specific purpose software application. In another exemplary embodiment, a software system can be one or more lines of hypertext markup language (HTML), extensible markup language (XML), a web browser plug-in, or other suitable code that operates in conjunction with a web browser application.

Order management system 102 is coupled to order planning system 104, materials system 106, manufacturing operations system 108 and shipping system 110 via communications medium 112 or other suitable communications media. As used herein, the term ‘couple,’ and its cognate terms such as ‘couples’ and ‘coupled,’ can include a physical connection (such as through one or more copper conductors), a virtual connection (such as one or more randomly assigned data memory locations of a data memory device), a logical connection (such as through one or more logical devices of a semiconducting circuit), a wireless connection, a hypertext transfer protocol (HTTP) connection, other suitable connections, or a suitable combination of such connections. In one exemplary embodiment, systems and components can be coupled to other systems and components through intervening systems and components, such as through an operating system of a general purpose server platform.

Communications medium 112 can be the Internet, a local area network, a wide area network, the public switched telephone network, a wireless network, a wireless local area network, a fiber-optic network, other suitable communications media, or a suitable combination of such communications media. Furthermore, the invention can be implemented in one exemplary embodiment without a network, such as where a given stage is coupled directly to other stages requiring feedback data from that stage.

Order management system 102 receives customer order data and generates order approval data and order feedback data. In one exemplary embodiment, a customer, a customer service representative, an e-commerce server, an agent or employee of a business, corporation, partnership, retail store outlet, warehouse, or other suitable organization providing goods, or other suitable user provides the customer order data. The customer order data can include data identifying the customer's name, customer's address, customer's contact information (such as phone number, fax number, mobile number, e-mail address, and other suitable contact information), customer's order information (such as part number or other identifying information of the requested item, unit description, quantity, unit cost, subtotal cost, shipping cost, tax, total cost, and other suitable order information), shipping information (such as carrier or class of delivery), payment information (such as cash-on-delivery, credit card, check, money order, electronic funds transfer, gift certificate, coupon, a suitable combination of such payment methods, or other suitable payment information), and other suitable customer order information. The order approval data can include data identifying whether the vendor will satisfy the customer's order or other suitable order approval information, the customer order data, estimated ship date, and other suitable data. The order feedback data can include data identifying the reason for denying a transaction, changes that need to be made to the customer order data, materials that were not included but are necessary for assembly, and other suitable data.

In one exemplary embodiment, order management system 102 can generate the order approval data based on the customer order data. For example, order management system 102 can generate the order approval data by processing the payment information identified within the customer order data, by determining the availability of materials or the requested item, and other suitable order approval methods. Order management system 102 can provide the order feedback data to any of the systems contained herein.

Order planning system 104 can be implemented in hardware, software, or a suitable combination of hardware and software, and can be one or more software systems operating on a general purpose server platform. Order planning system 104 receives the order approval data and generates order planning data and order planning feedback data. The order planning data can include data identifying the materials needed to fulfill the customer's order, the estimated build date, the schedule, the bill of materials (BOM), and other suitable information. The order planning feedback data can include data identifying changes such as a new estimated build date, new materials to fulfill the customer's order, and other suitable information. In one exemplary embodiment, order planning system 104 generates the order planning feedback data if the order planning data is not acceptable when compared to predetermined values. Order planning system 104 can then provide the order planning feedback data to any of the systems contained herein.

Materials system 106 can be implemented in hardware, software, or a suitable combination of hardware and software, and which can be one or more software systems operating on a general purpose server platform. Materials system 106 receives the order planning data and generates materials order data and materials feedback data. The materials order data can include data identifying the materials needed to fulfill the customer's order, the location of those materials, the need to order those materials, the vendor providing the materials, the cost, and other suitable information. The materials feedback data can include data identifying the status of materials' orders, the estimated build time, possible changes of materials, and other suitable information. For example, materials feedback data can reflect that a unit has not proceeded to assembly because the receipt of a material is pending. Materials feedback data can also reflect that the unit was returned from assembly due to an incorrect material received. In one exemplary embodiment, materials system 106 can provide the materials feedback data to update the order planning feedback data and other suitable data. Materials system 106 can then provide the materials feedback data to any of the systems contained herein.

Manufacturing operations system 108 can be implemented in hardware, software, or a suitable combination of hardware and software, and which can be one or more software systems operating on a general purpose server platform. Manufacturing operations system 108 receives materials receipt data and generates manufacturing completion data and completion feedback data. The materials receipt data can include data identifying the date on which the materials reflected in the materials order data were received, the location of those materials, the vendor that provided the materials, the cost of the materials, and other suitable information. The manufacturing completion data can include data identifying the BOM, the employee, agent or device completing assembly, the build time of the unit, the actual time of completion of each step, the quality of the unit after testing, and other suitable information. The completion feedback data can include data identifying changes in the BOM as a result of testing the unit, the expected shipping date, the status of the unit during assembly, and other suitable information. In one exemplary embodiment, manufacturing operations system 108 can provide the completion feedback data to update the materials feedback data and other suitable data. Manufacturing operations system 108 can then provide the completion feedback data to any of the systems contained herein.

Shipping system 110 can be implemented in hardware, software, or a suitable combination of hardware and software, and which can be one or more software systems operating on a general purpose server platform. Shipping system 110 receives the manufacturing completion data and generates shipping date data and shipping feedback data. The shipping date data can include data identifying the customer order data, the date the item is to be shipped to the customer, whether the unit was shipped on that date, the actual shipping date of the item, and other suitable information. The shipping feedback data can include data identifying the status of the unit during the shipping step, the actual shipping date of the item, the reason the deadline was not met (if any), and other suitable information. In one exemplary embodiment, shipping system 110 can provide the shipping feedback data to update the completion feedback data and other suitable data. Shipping system 110 can then provide the shipping feedback data to any of the systems contained herein.

In operation, system 100 allows tracking of feedback data and other suitable data while receiving customer order data, generating order approval data, order planning data, and materials order data, receiving materials receipt data, generating manufacturing completion data and shipping date data, and other suitable functions. System 100 permits an organization providing goods to identify the status of a unit during each stage of manufacturing and other suitable functions.

One of ordinary skill in the art will also recognize that the functions of system 100 can also be used advantageously in an audit process, such as where tracking of feedback data at each stage is performed manually. While an audit process does not provide many of the advantages of system 100, such as the ability to generate notification data, the audit process may be adequate for application to some processes, such as those where there is little or no variation between the types of goods or services being generated so that delay in an individual order can be accommodated by filling that order with goods or services from another order, such as one that has been cancelled. Likewise, the audit process can be used for predetermined stages of the order fulfillment process only (such as stages that typically generate no feedback data or that introduce no delay in order fulfillment), while the rest of system 100 can be used for the remaining stages.

FIG. 2 is a diagram of a system 200 for receiving customer order data and generating order approval data in accordance with an exemplary embodiment of the present invention. System 200 includes order management system 102 and order placement system 202, order entry system 204, and credit approval system 206, each of which can be implemented in hardware, software, or a suitable combination of hardware and software, and can be one or more software systems operating on a general purpose processing platform.

Order placement system 202 receives customer order data, such a standard model number, additional data identifying any accessories that should be included with the standard model, shipping date data, customer identification data, and other suitable data. Order placement system 202 can include order-checking functionality, such as to prevent an order from being placed that includes accessories that are incompatible with the standard model number, to identify additional accessories that may be required in order to support the ordered accessories, to verify that a complete address has been entered, or other suitable order-checking functionality. Order placement system 202 can include schedule data with the order data, such standard schedule data, expedited schedule data, order management schedule data, or other suitable data.

Order entry system 204 receives customer order data and generates order entry data including order entry feedback data. The order entry data can include the date of order entry, customer order data, and other suitable information. The order entry feedback data can include order placement system 202 feedback data (such as order correction data, schedule correction data, data identifying that the ordered goods or services have been discontinued, notification data notifying an operator to contact the customer for selection of alternate goods and services, schedule delay data indicating that the customer order data was received from order placement system 202 after schedule data requirements), or other suitable feedback data.

Credit approval system 206 receives order entry data and generates credit approval data including credit approval feedback data. The credit approval data can include transaction approval data from a financial institution, transaction denial data, denial reason data, credit approval delay data, delay reason data, credit approval data, and other suitable information. The credit approval feedback data can include order entry system 204 feedback data (such as notification data notifying an operator to contact the customer for correction of credit approval data and schedule delay data indicating that the order entry data was received from order entry system 204 after schedule data requirements), order placement system 202 feedback data, or other suitable feedback data.

In operation, system 200 allows customer order data to be received and processed and for feedback data to be generated to allow mistakes or reasons for delay to be readily identified and corrected. Schedule data associated with each order can be checked at each stage of order processing to detect when delay is occurring, so as to prevent delay from affecting the shipment date of that order and to allow any problems that may result in delay for other orders to be readily corrected.

FIG. 3 is a diagram of a system 300 for generating order planning data and order planning feedback data in accordance with an exemplary embodiment of the present invention. System 300 includes order planning system 104 and order scheduling system 302, bill of materials system 304, and bill of materials entry system 306, each of which can be implemented in hardware, software, or a suitable combination of hardware and software, and which can be one or more software systems operating on a general purpose processing platform.

Order scheduling system 302 receives order approval data and generates order schedule data including order schedule feedback data. The order schedule data can include data identifying the schedule of operations for the unit to ship on time to the customer, order approval data, and other suitable information. The order schedule feedback data can include credit approval system 206 feedback data (such as credit required change data and credit approval system delay data), order entry system 204 feedback data, order placement system 202 feedback data, or other suitable feedback data.

Bill of materials system 304 receives the order approval data and generates bill of materials data including bill of materials feedback data. The bill of materials data can include parts list data, parts number data, order approval data, and other suitable information. The bill of materials feedback data can order scheduling system 302 feedback data (such as schedule correction data, schedule revision data, and scheduling system delay data), credit approval system 206 feedback data, order entry system 204 feedback data, order placement system 202 feedback data, and other suitable feedback data.

Bill of materials entry system 306 receives the bill of materials data and generates bill of materials entry data including bill of materials entry feedback data. The bill of materials entry data can include entry completion data, bill of materials data, and other suitable data. The bill of materials entry feedback data can include bill of materials system 304 feedback data (such as bill of materials system delay data and bill of materials error data), order scheduling system 302 feedback data, credit approval system 206 feedback data, order entry system 204 feedback data, order placement system 202 feedback data, and other suitable feedback data.

In operation, system 300 allows order planning data to be generated and updated with feedback data, so as to ensure on-time order processing, early correction of problems that may delay an order, and identification of organization inefficiencies.

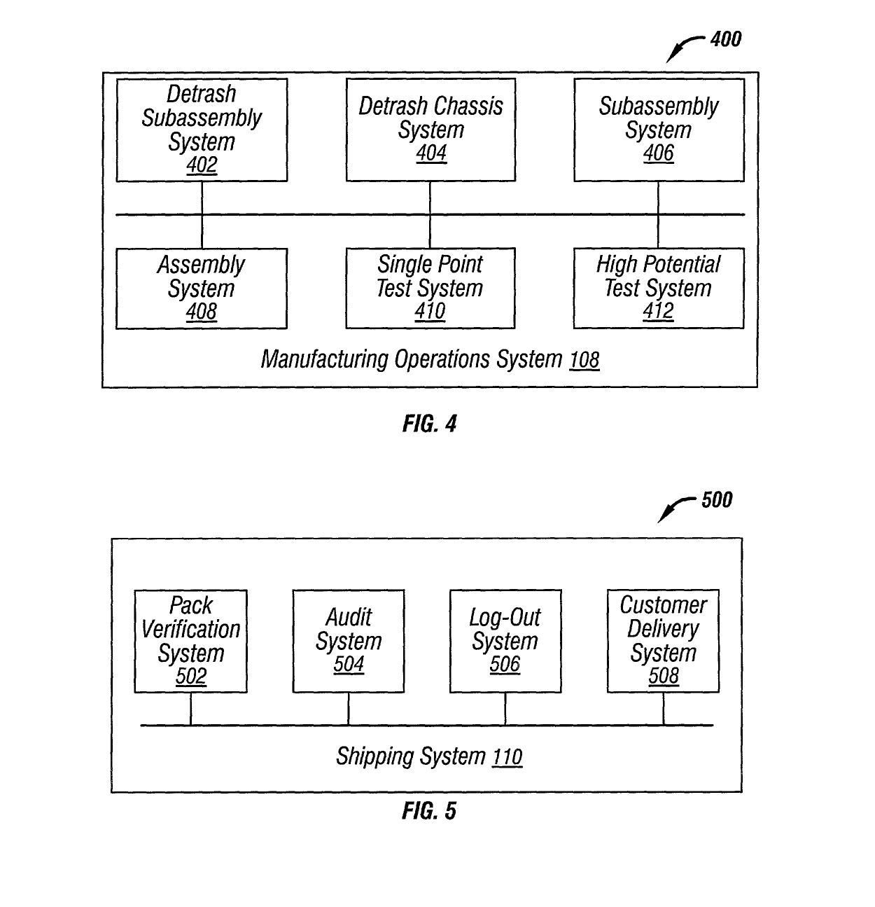

FIG. 4 is a diagram of a system 400 for providing feedback data during and subsequent to manufacturing operations in accordance with an exemplary embodiment of the present invention. System 400 includes manufacturing operations system 108 and detrash subassembly system 402, detrash chassis system 404, subassembly system 406, assembly system 408, single point test system 410, and high potential test system 412, each of which can be implemented in hardware, software, or a suitable combination of hardware and software, and which can be one or more software systems operating on a general purpose processing platform.

Detrash subassembly system 402 receives materials receipt data and generates subassembly detrashed data including detrash subassembly feedback data. The subassembly detrashed data can include detrash completion date data, materials receipt data, and other suitable data. The detrash subassembly feedback data can include materials system 106 feedback data (such as materials receipt delay data, materials damage data, or incomplete materials data), bill of materials system 304 feedback data, order scheduling system 302 feedback data, credit approval system 206 feedback data, order entry system 204 feedback data, order placement system 202 feedback data, and other suitable feedback data.

Detrash chassis system 404 receives materials receipt data and generates chassis detrashed data including detrash chassis feedback data. The chassis detrashed data can include detrash completion date, materials receipt data, and other suitable data. The detrash chassis feedback data can include can include materials system 106 feedback data, bill of materials system 304 feedback data, order scheduling system 302 feedback data, credit approval system 206 feedback data, order entry system 204 feedback data, order placement system 202 feedback data, and other suitable feedback data.

Subassembly system 406 receives subassembly detrashed data and generates subassembly complete data including subassembly feedback data. The subassembly complete data can include the date on which the subassembly was finished, subassembly detrashed data, and other suitable data. The subassembly feedback data can include detrash subassembly system 402 feedback data (such as detrash incomplete data, subassembly damage data, and detrash delay data), materials system 106 feedback data, bill of materials system 304 feedback data, order scheduling system 302 feedback data, credit approval system 206 feedback data, order entry system 204 feedback data, order placement system 202 feedback data, and other suitable feedback data.

Assembly system 408 receives subassembly complete data and chassis detrashed data and generates assembly complete data including assembly feedback data. The assembly complete data can include the date on which the assembly was finished, subassembly complete data, chassis detrashed data, and other suitable data. The assembly feedback data can include detrash chassis system 404 feedback data (such as detrash incomplete data, chassis damage data, and detrash delay data), subassembly system 406 feedback data (such as subassembly incomplete data, subassembly damage data, and subassembly delay data), materials system 106 feedback data, bill of materials system 304 feedback data, order scheduling system 302 feedback data, credit approval system 206 feedback data, order entry system 204 feedback data, order placement system 202 feedback data, and other suitable feedback data.

Single point test system 410 receives assembly complete data and generates single point test data including single point test feedback data. The single point test data can include test results data, test completion date data, assembly complete data and other suitable data. The single point test feedback data can include assembly system 408 feedback data (such as assembly delay data, assembly incomplete data, and assembly damaged data), detrash chassis system 404 feedback data, subassembly system 406 feedback data, materials system 106 feedback data, bill of materials system 304 feedback data, order scheduling system 302 feedback data, credit approval system 206 feedback data, order entry system 204 feedback data, order placement system 202 feedback data, and other suitable feedback data.

High potential test system 412 receives single point test data and generates high potential test data including high potential test feedback data. The high potential test data can include high potential test complete data, high potential test results data, single point test data, and other suitable data. The high potential test feedback data can include single point test system 410 feedback data (such as test delay data and assembly damaged data), assembly system 408 feedback data, detrash chassis system 404 feedback data, subassembly system 406 feedback data, materials system 106 feedback data, bill of materials system 304 feedback data, order scheduling system 302 feedback data, credit approval system 206 feedback data, order entry system 204 feedback data, order placement system 202 feedback data, and other suitable feedback data.

In operation, system 400 allows manufacturing operations data to be generated and updated with feedback data, so as to ensure on-time order processing, early correction of problems that may delay an order, and identification of organization inefficiencies.

FIG. 5 is a diagram of a system 500 for generating shipping date data and feedback data in accordance with an exemplary embodiment of the present invention. System 500 includes shipping system 110 and pack verification system 502, audit system 504, log-out system 506, and customer delivery system 508, each of which can be implemented in hardware, software, or a suitable combination of hardware and software, and which can be one or more software systems operating on a general purpose processing platform.

Pack verification system 502 receives high potential test data and generates pack verification data including pack verification feedback data. Pack verification data can include pack verification complete data, high potential test data, and other suitable data. Pack verification feedback data can include high potential test system 412 feedback data (such as high potential test delay data and assembly damaged data), single point test system 410 feedback data, assembly system 408 feedback data, detrash chassis system 404 feedback data, subassembly system 406 feedback data, materials system 106 feedback data, bill of materials system 304 feedback data, order scheduling system 302 feedback data, credit approval system 206 feedback data, order entry system 204 feedback data, order placement system 202 feedback data, and other suitable feedback data.

Audit system 504 receives pack verification data and generates audit completion data including audit system feedback data. The audit completion data can include audit completion date data, audit completion results data (such as the percentage of units passing a Factory Product Integrity Audit, a Customer-Driven Integrity Test, or other suitable audits), pack verification data, and other suitable data. The audit system feedback data can include pack verification system 502 feedback data (such as pack verification delay data and package damaged data), high potential test system 412 feedback data, single point test system 410 feedback data, assembly system 408 feedback data, detrash chassis system 404 feedback data, subassembly system 406 feedback data, materials system 106 feedback data, bill of materials system 304 feedback data, order scheduling system 302 feedback data, credit approval system 206 feedback data, order entry system 204 feedback data, order placement system 202 feedback data, and other suitable feedback data.

Log-out system 506 receives manufacturing completion data and generates log-out data including log-out feedback data. The log-out data can include a log-out date, shipping address data, manufacturing completion data, and other suitable data. The log-out feedback data can include audit system 504 feedback data (such as audit delay data and package damaged data), pack verification system 502 feedback data, high potential test system 412 feedback data, single point test system 410 feedback data, assembly system 408 feedback data, detrash chassis system 404 feedback data, subassembly system 406 feedback data, materials system 106 feedback data, bill of materials system 304 feedback data, order scheduling system 302 feedback data, credit approval system 206 feedback data, order entry system 204 feedback data, order placement system 202 feedback data, and other suitable feedback data.

Customer delivery system 508 receives log-out data and generates order completion data and customer delivery feedback data. The order completion data can include order delivery date, customer follow-up data, log-out data, and other suitable data. The customer delivery feedback data can include log-out system 506 feedback data (such as audit delay data and package damaged data), audit system 504 feedback data, pack verification system 502 feedback data, high potential test system 412 feedback data, single point test system 410 feedback data, assembly system 408 feedback data, detrash chassis system 404 feedback data, subassembly system 406 feedback data, materials system 106 feedback data, bill of materials system 304 feedback data, order scheduling system 302 feedback data, credit approval system 206 feedback data, order entry system 204 feedback data, order placement system 202 feedback data, and other suitable feedback data.

In operation, system 500 allows shipping data to be generated and updated with feedback data, so as to ensure on-time order processing, early correction of problems that may delay an order, and identification of organization inefficiencies.

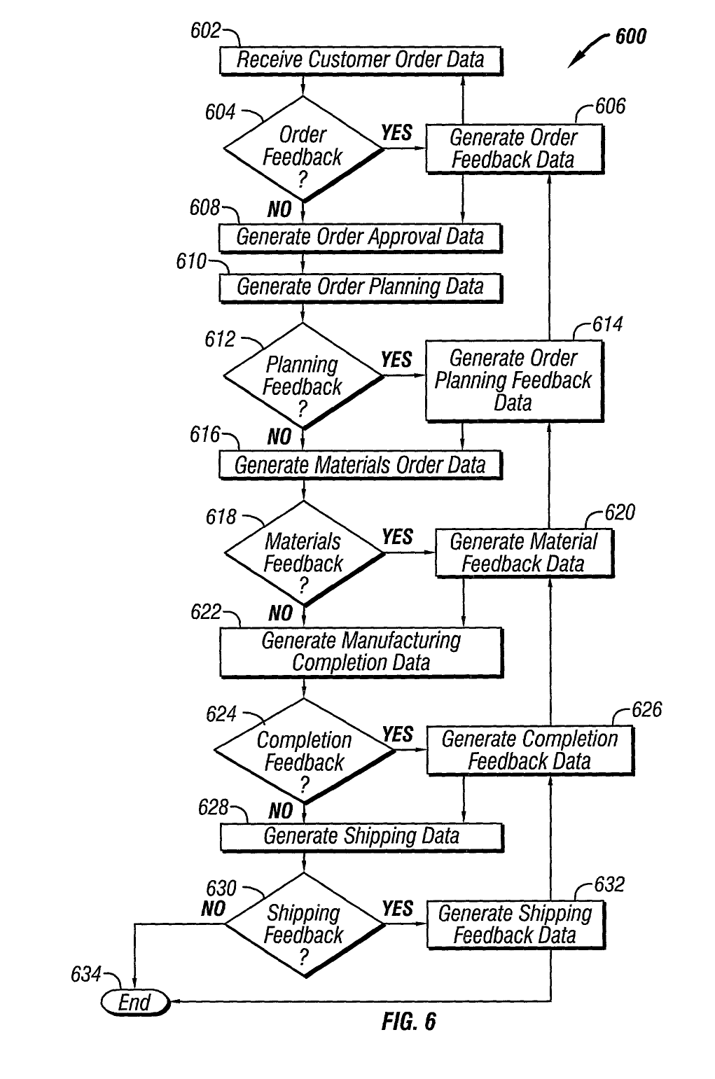

FIG. 6 is a flowchart of a method 600 for order-based management in accordance with an exemplary embodiment of the present invention. Method 600 begins at 602 where the customer order data is received. The method then proceeds to 604 where it is determined whether order feedback is required. If so, the method proceeds to 606 where order feedback data is generated. The method then returns to 602 if correction is required, or proceeds to 608 if order feedback or correction is not required.

At 608, order approval data is generated, and the method proceeds to 610. At 610, order planning data is generated. In one exemplary embodiment, the order planning data can reflect the materials to be used to assemble the unit, the completion dates for each step, and other suitable information. The method then proceeds to 612 where it is determined whether planning feedback is required. If planning feedback is required, the method proceeds to 614 where order planning feedback is generated. The method then returns to a suitable previous step if correction is required, or proceeds to 616 if planning feedback or correction is not required.

At 616, materials order data is generated, and the method proceeds to 618 where it is determined whether materials feedback is required, such as if required materials were not previously identified. If materials feedback is required, the method proceeds 620 where materials feedback data is generated. The method then returns to a suitable previous step if correction is required, or proceeds to 622 if materials feedback or correction is not required.

At 622, manufacturing completion data is generated, and the method proceeds to 624 where it is determined whether completion feedback is required, such as if manufacturing was not completed due to incomplete parts. If completion feedback is required, the method proceeds to 626 where completion feedback data is generated. The method then returns to a suitable previous step if correction is required, or proceeds to 628 if completion feedback or correction is not required.

At 628, shipping data is generated, and the method proceeds to 630 where it is determined whether shipping feedback is required, such as if shipping did not occur on time because of test failure. If shipping feedback is required, the method proceeds to 632 where shipping feedback data is generated. The method then returns to a suitable previous step if correction is required, or proceeds to 634 if shipping feedback or correction is not required.

In operation, method 600 allows for order-based management. Method 600 provides feedback data at essential steps to allow monitoring of the performance of these steps. The feedback data can be used to correct problems, improve overall efficiency, and decrease turnaround time on unit assemblies.

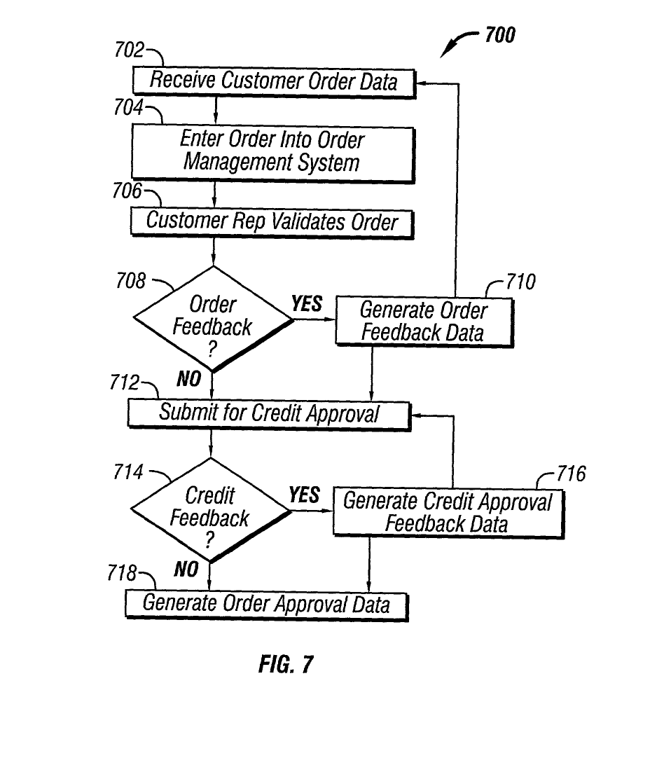

FIG. 7 is a flowchart of a method 700 for receiving customer orders and generating order approval data in accordance with an exemplary embodiment of the present invention. Method 700 begins at 702 where the customer order data is received. In one exemplary embodiment, the customer order data can be received from an electronic commerce server or other suitable electronic ‘store.’ The method then proceeds to 704.

At 704, the customer order data is entered into an order management system. The method then proceeds to 706 where the customer representative or other suitable agent of the vendor validates the customer order data. The method then proceeds to 708 where it is determined whether order feedback is required. If order feedback is required, the method proceeds to 710 where order feedback data is generated. The method then returns to a suitable previous step if correction is required, or proceeds to 612 if order feedback or correction is not required.

At 712, the customer order data is submitted for credit approval. The method then proceeds to 714 where it is determined whether credit feedback is required. If credit feedback is required, the method proceeds to 716 where credit approval feedback data is generated, such as a change in the amount of credit needed, a request for additional credit approval data, a notification that credit was denied, or other suitable feedback data. The method then returns to a suitable previous step if correction is required, or proceeds to 718 if credit approval feedback or correction is not required. At 718, order approval data is generated.

In operation, method 700 allows customer order data to be received and order approval data to be generated. Method 700 provides feedback data at essential steps to allow monitoring of the performance of these steps. The feedback data can be used to correct problems, improve overall efficiency, and decrease turnaround time on unit assemblies.

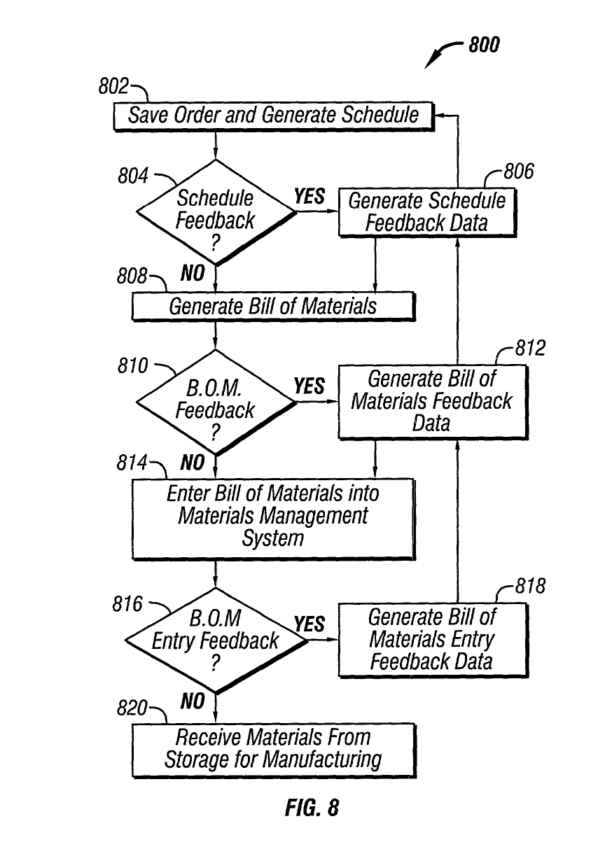

FIG. 8 is a flowchart of a method 800 for generating order planning data and feedback data in accordance with an exemplary embodiment of the present invention. Method 800 begins at 802 where the customer order data is saved and schedule data is generated. The method then proceeds to 804 where it is determined whether schedule feedback is required. If schedule feedback is required, the method proceeds to 806 where schedule feedback data is generated. The method then returns to a suitable previous step if correction is required, or proceeds to 808 if schedule feedback or correction is not required.

At 808, bill of materials data is generated, such as by generating a list of materials that is required to manufacture the ordered item. The method then proceeds to 810 where it is determined whether bill of materials feedback is required, whether certain materials are missing that are required, such as if materials are present that can cause a conflict with other materials or if required materials have not been provided. If bill of materials feedback is required, the method proceeds to 812 where bill of materials feedback data is generated. The method then returns to a suitable previous step if correction is required, or proceeds to 814 if bill of materials feedback or correction is not required.

At 814, the bill of materials data is entered into a materials management system. The method then proceeds to 816 where it is determined whether the bill of materials entry feedback is required, such as when the bill of materials was provided after the schedule deadline for doing so. If bill of materials entry feedback is required, the method proceeds to 818 where the bill of materials entry feedback data is generated. The method then returns to a suitable previous step if correction is required, or proceeds to 820 if bill of materials entry feedback or correction is not required. At 820, the materials required for assembly of the ordered item are ordered or retrieved from storage for manufacturing.

In operation, method 800 allows order data to be received and materials to be ordered or retrieved from storage for manufacturing. Method 800 provides feedback data at essential steps to allow monitoring of the performance of these steps. The feedback data can be used to correct problems, improve overall efficiency, and decrease turnaround time on unit assemblies.

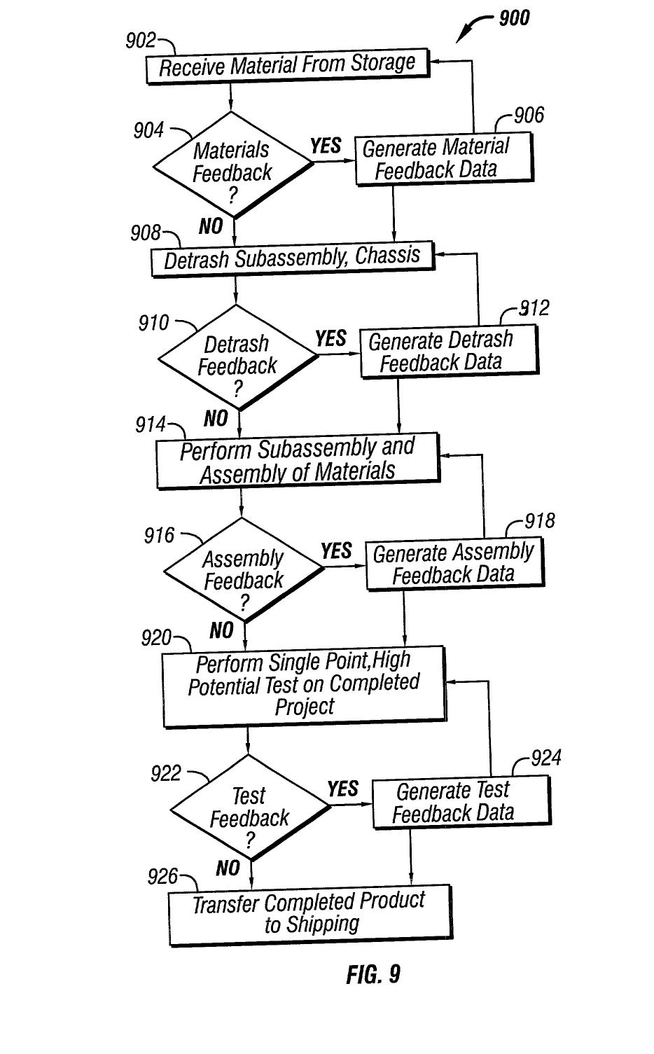

FIG. 9 is a flowchart of a method 900 for generating manufacturing completion data and feedback data in accordance with an exemplary embodiment of the present invention. Method 900 begins at 902 where the materials required to manufacture an item are received from storage. The method then proceeds to 904 where it is determined whether materials feedback is required, such as if the materials are not correct. If materials feedback is required, the method proceeds to 906 where materials feedback data is generated. The method then returns to a suitable previous step if correction is required, or proceeds to 908 if materials feedback or correction is not required.

At 908, the subassembly and chassis are detrashed, meaning that packaging materials are removed and discarded and the subassembly and chassis are organized for manufacturing operations. The method then proceeds to 910 where it is determined whether detrash feedback is required, such as where a schedule deadline has passed, or where damage has occurred. If detrash feedback is required, the method proceeds to 912 where detrash feedback is generated. The method then returns to a suitable previous step if correction is required, or proceeds to 914 if detrash feedback or correction is not required.

At 914, subassembly and assembly of materials is performed. The method then proceeds to 916 where it is determined whether assembly feedback is required, such as where improper parts have been provided. If assembly feedback is required, the method proceeds to 918 where assembly feedback data is generated. The method then returns to a suitable previous step if correction is required, or proceeds to 920 if assembly feedback or correction is not required.

At 920, one or more tests are performed, such as a single point test, a high potential test, or other suitable tests. The method then proceeds to 922 where it is determined whether the test feedback is required, such as when the test is completed after a scheduled completion date. If test feedback is required, the method proceeds to 924 where test completion data is generated. The method then returns to a suitable previous step if correction is required, or proceeds to 926 if test completion feedback or correction is not required. At 926, the completed product is transferred to shipping for shipment to the customer.

In operation, method 900 allows materials to assembled into a finished product and shipped to a customer. Method 900 provides feedback data at essential steps to allow monitoring of the performance of these steps. The feedback data can be used to correct problems, improve overall efficiency, and decrease turnaround time on unit assemblies.

In view of the above detailed description of the present invention and associated drawings, other modifications and variations will now become apparent to those skilled in the art. It should also be apparent that such other modifications and variations may be effected without departing from the spirit and scope of the present invention.

What is claimed is:

1. A system for order-based management comprising:
an order management system receiving customer order data and generating order approval data;
an order planning system receiving the order approval data and generating order planning data and feedback data;
a materials system receiving the order planning data and generating materials order data and the feedback data;
a manufacturing operations system receiving materials receipt data and generating manufacturing completion data and the feedback data;
a shipping system receiving the manufacturing completion data and generating shipping date data and the feedback data; and
wherein the feedback data is provided to the order management system, the order planning system, the materials system, the manufacturing operations system, and the shipping system.

2. The system of claim 1 wherein the order management system further comprises an order entry system receiving the customer order data and generating order entry data, and the feedback data includes customer order correction data.

3. The system of claim 1 wherein the order management system further comprises a credit approval system receiving the customer order data and generating credit approval data, and the feedback data includes credit approval delay data.

4. The system of claim 1 wherein the order planning system further comprises a bill of materials system receiving the order approval data and generating bill of materials data, and the feedback data includes order approval delay data.

5. The system of claim 1 wherein the order planning system further comprises a bill of materials entry system receiving the bill of materials data and generating bill of materials entry data, and the feedback data includes bill of materials completion delay data.

6. The system of claim 1 wherein the manufacturing operations system further comprises a subassembly detrash system receiving subassembly receipt data and generating subassembly completion data, and the feedback data includes subassembly receipt delay data.

7. The system of claim 1 wherein the manufacturing operations system further comprises a chassis detrash system receiving chassis receipt data and generating chassis completion data, and the feedback data includes chassis receipt delay data.

8. The system of claim 1 wherein the manufacturing operations system further comprises an assembly system receiving the materials receipt data and generating unit test initiation data, and the feedback data includes bill of materials correction data.

9. The system of claim 1 wherein the shipping system further comprises a test system receiving unit test data and generating test completion data, and the feedback data includes test failure data.

10. The system of claim 1 wherein the shipping system further comprises an audit system receiving unit audit data and generating audit completion data, and the feedback data includes audit alert data.

11. The system of claim 1 wherein the shipping system further comprises a customer delivery system receiving delivery data and generating order completion data, and the feedback data includes delivery delay data.

12. A method for order-based management comprising:
receiving customer order data and generating order planning data;
receiving the order planning data and generating materials order data and feedback data;
receiving materials receipt data and generating manufacturing completion data and the feedback data;
receiving the manufacturing completion data and generating shipping date data and the feedback data; and
providing the feedback data to one or more order management stages.

13. The method of claim 12 wherein receiving the customer order data and generating the order approval data further comprises:
entering the customer order data into an order entry system;
validating the customer order data in the order entry system; and
generating order entry feedback data if the customer order data in the order entry system is not validated.

14. The method of claim 12 wherein receiving the order planning data and generating materials order data and feedback data further comprises;
receiving the order planning data and generating bill of materials data;
determining whether the bill of materials data is correct; and
generating bill of materials feedback data if the bill of materials data is not correct.

15. The method of claim 14 wherein the bill of materials feedback data is generated after materials have been detrashed for assembly.

16. The method of claim 12 wherein receiving the materials receipt data and generating the manufacturing completion data and the feedback data comprises:
determining whether a materials receipt date is after a materials receipt schedule date; and
generating materials receipt delay feedback data if the materials receipt date is after the materials receipt schedule date.

17. The method of claim 12 wherein receiving the manufacturing completion data and generating shipping date data and the feedback data comprises:
determining whether a manufacturing completion date is after a manufacturing completion schedule date; and
generating manufacturing completion delay feedback data if the manufacturing completion date is after the manufacturing completion schedule date.

18. The method of claim 12 wherein receiving the manufacturing completion data and generating shipping date data and the feedback data comprises:
determining whether testing completion data includes test failure data and incorrect materials data; and
generating bill of materials feedback data if the testing completion data includes the test failure data and the incorrect materials data.

19. The method of claim 12 wherein the method is performed as an audit on a predetermined number of orders.

20. The method of claim 12 wherein the method is performed on each order.
